(19) United States
(12) Patent Application Publication
(10) Pub. No.: US 2003/0078925 A1
(43) Pub. Date: Apr. 24, 2003

(54) Method and system for reading authorized data

(75) Inventors: Hung-Liang Chiu, Taipei (TW); Win-Chee Yu, Taipei (TW); Ming-Hsiao Hsieh, Taipei (TW)

Correspondence Address: MR. PETER F. CORLESS, EDWARDS & ANGELL, LLP, 101 FEDERAL STREET, BOSTON, MA, 02110, US

(73) Assignee: Inventec Corporation, Taiwan (TW)

(21) Appl. No.: 10/002,840

(22) Filed: Oct. 23, 2001

(51) Int. Cl. G06F 17/30

(52) U.S. Cl. 707/9

(57) ABSTRACT

A method and a system for reading authorized data are proposed. With a network connection established among a system for reading authorized data, a terminal device and an application service provider, the system for reading authorized data allows a user at the terminal device to obtain data generated by operating an application program system of the application service provider, wherein the system for reading authorized data is pre-formed with a database used for storing the data generated by operating the application program system. Therefore, the user merely submits a data-reading request to the system for reading authorized data, which retrieves data requested by the user from the database. In the foregoing method and system, no startup program of the application service provider is necessarily installed in the terminal device, so that cost in purchasing authorization for using the application program system and load of the application program system are decreased.

### FIELD OF THE INVENTION

The present invention relates to methods and systems for reading authorized data, and more particularly, to a method and a system for reading authorized data, allowing a user at a terminal device to read data produced by operating an application program system of an application service provider.

### BACKGROUND OF INVENTION

Rapid development of electronic information and internet systems allows trades to be conducted by interaction and application between computers and communication networks. Therefore, an enterprise resource planning (ERP) system is introduced to a commercially automated enterprise for integrating internal information systems of various departments in the enterprise, so as to effectively make use of resources in the enterprise.

An application service provider (ASP) of the ERP system provides a network interface for supporting its application program with client/server architecture thereon, so as to authorize ERP products to clients in a secure manner as to directly submit product requests and access associated information. Some other products are authorized to commercially cooperated partners, allowing information to be accessed and product requests to submitted in a self-service manner, so as to improve correlation between the ASP and the cooperated partners.

The application program system provided by the ASP can be executed by a user in a first manner that a start-up program is conducted through a client interface provided by the ASP, or in a second manner that a batch job is performed through the application program system provided by the ASP for transmitting document files to a terminal device.

The first manner needs the user to pre-install in its terminal device the start-up program provided by the ASP, and to purchase authorization from the ASP. This therefore increases the cost in purchasing the authorization and installing the start-up program for the user e.g. an enterprise.

Referring to FIG. 1, it illustrates system architecture required for conducting the foregoing second manner. If a user at a terminal device 1 submits a request for reading data to an ASP website 3 through a network system 2, an application program system (referred to as ERP system 30 hereafter) provided by the ASP website 3 is executed for producing associated data as required by the user, wherein a file server 31 and a database server 32 installed by the ASP website 3 are used to transmit the associated data produced by the ERP system 30 to the terminal device 1 and display the data on a browser 10. However, the data are transmitted among the ERP system 30, the file server 31 and the database server 32 in a batch-job manner, and thus immediateness can not be preferably achieved.

Moreover, in the use of the foregoing two manners, the operation of the application program system is necessary for providing the user with the required data. This therefore increases load of the application program system in operation.

Therefore, besides aiming for decreasing the cost for the enterprise in purchasing the authorization and installing the start-up program, it is further critical to reduce the load of the application program system in operation.

### SUMMARY OF TE INVENTION

A primary objective of the present invention is to provide a method and a system for reading authorized data, which can reduce load of an application program system in operation, and simplify installation of a start-up program as required for using the application program system provided by an application service provider, as well as decrease cost in purchasing authorization from the application service provider for an enterprise.

In accordance with the foregoing and other objectives, the present invention proposes a method and a system for reading authorized data. The method for reading authorized data of the invention, with a network connection established among a system for reading authorized data, a terminal device and an application service provider, allows a user at the terminal device to obtain data generated by operating an application program system of the application service provider in the use of the system for reading authorized data, wherein the system for reading authorized data is pre-formed with a database used for storing the data generated by operating the application program system.

The method for reading authorized data comprises the steps of: (1) determining via the system for reading authorized data if a data-reading request is submitted by the user at the terminal device, wherein if the data-reading request is received by the system for reading authorized data, then step (2) is followed, or else, the step (1) is repeated; (2) determining via the system for reading authorized data if data requested by the user is availably stored in the database, wherein if no data requested by the user is available, then step (4) is followed, or else, step (3) is followed; (3) retrieving the data requested by the user via the system for reading authorized data from the database, and displaying the retrieved data on a browser of the terminal device; then, repeating the step (1); (4) submitting a data-downloading inquiry via the system for reading authorized data to the application service provider according to the data-reading request submitted by the user; (5) determining via the system for reading authorized data if the data requested by the user are transmitted from the application service provider, wherein if no data requested by the user is received by the system for reading authorized data, then the step (4) is repeated, or else, step (6) is followed; and (6) downloading the requested data transmitted from the application service provider via the system for reading authorized data to the database for storage, and then repeating the step (3).

In the prior art, an application program system of an application service provider correspondingly operates according to data-reading requests submitted by all users; this therefore increases load of the application program system. Moreover, the user who submits the data-reading request needs to purchase authorization from the application service provider for using the application program system. However, the system for reading authorized data of the invention pre-integrates data generated by operating the application program system of the application service provider, and transmits the integrated data to a database of the system for reading authorized data. Therefore, a user at a terminal device merely submits a data-reading request to the system for reading authorized data, which retrieves data requested by the user from the database. This therefore effectively resolves the foregoing drawbacks in the prior art.

The system for reading authorized data comprises: the database for storing the data generated by operating the application program system of the application service provider; a processing module for receiving the data-reading request submitted by the user at the terminal device, and searching in the database for the data requested by the user according to the received data-reading request, wherein if no data requested by the user is availably searched, the processing module submits a data-reading inquiry to the application service provider according to the received data-reading request; and a downloading module for processing the data requested by the user when the processing module receiving the requested data transmitted from the application service provider, and storing the processed data in the database to be read by the user at the terminal device.

In the use of the method and system for reading authorized data of the invention, a start-up program of a client interface provided by the application service provider is not necessarily installed in the terminal device and executed by the user at the terminal device, so that cost for an enterprise in purchasing authorization for using the application program system can be reduced, and load of the application program system can be decreased.

Herein, the system for reading authorized data can be selectively constructed in a server host.

### BRIEF DESCRIPTION OF THE DRAWINGS

The present invention can be more fully understood by reading the following detailed description of the preferred embodiments, with reference made to the accompanying drawings wherein:

FIG. 1 (PRIOR ART) is a schematic block diagram showing basic architecture of a conventional system for reading authorized data,

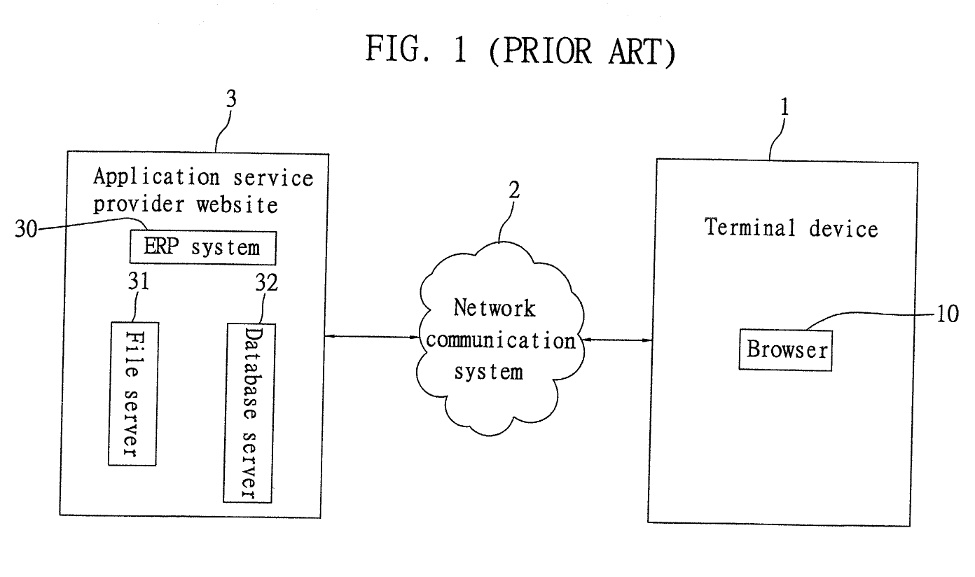

FIG. 2 is a schematic block diagram showing basic architecture of the system for reading authorized data of the invention; and

FIG. 3 is a schematic diagram showing the steps depicting the method for reading authorized data in the use of the system for reading authorized data of the invention.

### DETAILED DESCRIPTION OF THE PREFERRED EMBODIMENT

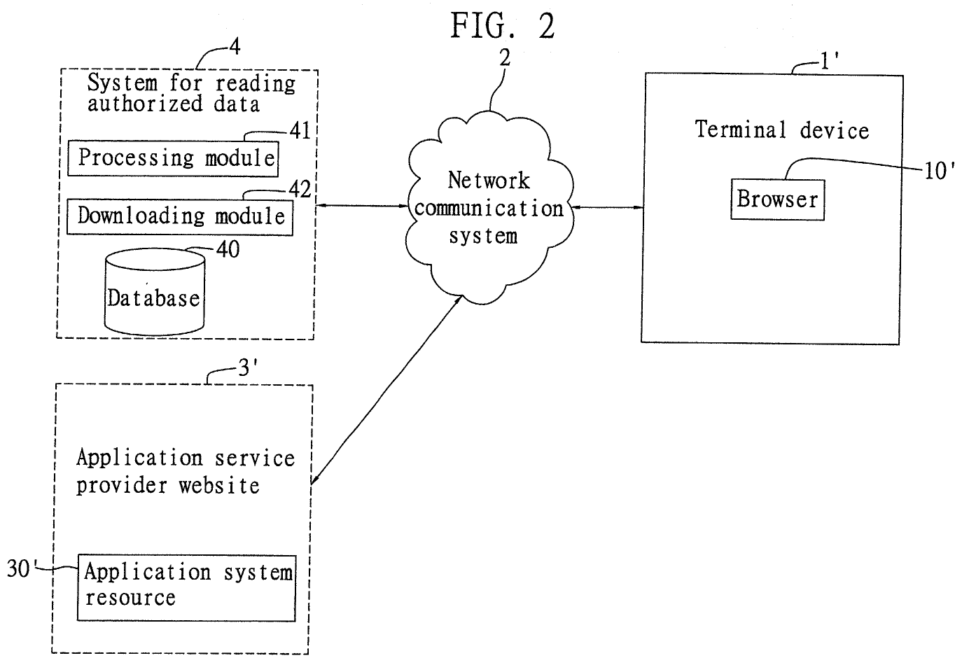

Referring to FIG. 2, it illustrates basic architecture of the system for reading authorized data of the invention. As shown in the drawing, the system for reading authorized data 4 of the invention is constructed between a terminal device 1′ and world wide web (not shown). The system for reading authorized data 4 acts as a server host to be connected to an application service provider (ASP) website 3′ through a network communication system 2, wherein the system for reading authorized data 4 and the ASP website 3′ are included in the world wide web. A user at the terminal device 1′ can be, for example, an enterprise employee, an enterprise client, etc. The ASP website 3′ can be constructed by an ASP such as Oracle software corporation for providing application system resources 30′, which are commercial automation tools in response to electronic commerce, and include e.g. enterprise resource planning (ERP), supply chain management (SCM) and customer relationship management (CRM). The system for reading authorized data 4 comprises a database 40, a processing module 41 and a downloading module 42 After establishing the network connection between the system for reading authorized data 4 and the terminal device 1′, the processing module 41 receives a data-reading request generated by the terminal device 1′, so as to search in the database 40 for associated data according to the data-reading request, and allow the processing module 41 to display the associated data on a browser 10′ of the terminal device 1′. Alternatively, the system for reading authorized data 4 can submit a data-reading inquiry to the ASP website 3′ for making the ASP search in a database server (not shown) thereof for the associated data according to the data-reading request.

The database 40 is provided with a plurality of data tables, including e.g. evaluation sheet, purchase record, data request record, etc. The data tables are constructed in a manner that, after receiving the data-reading request, the ASP website 3′ transmits associated files or records produced by clients of an enterprise using the application system resources 30′ to the database 40 for storage, wherein the files or records are pre-stored in the database server (not shown) of the ASP.

When no associated data relating to the data-reading request transmitted from the terminal device 1′ is available in the database 40, the processing module 41 generates a data-reading inquiry in response to the data-reading request to the ASP website 3′ in a request for comment (RFC) manner. Records and files of trades established for enterprises, clients, or between the enterprises and clients are numerically labeled as RFC document numbers, for allowing a desired document to be retrieved according to its corresponding RFC document number; that is, the processing module 41 transmits a RFC document number to the ASP website 3′, so as to inform the ASP website 3′ of data required by the processing module 41 according to the transmitted RFC document number.

After the processing module 41 receives the data transmitted from the ASP website 3′, the downloading module 42 processes the data to be in the form of tables and downloads the tables in the database 40 for storage, while the processing module 41 transmits the tables of data to the browser 10′ of the terminal device 1′ for storage.

The system for reading authorized data 4 of the invention integrates and transmits data generated by operating the application system resources 30′ of the ASP website 3′ to the database 40. If a user at the terminal device 1′ desires to access the data produced by the application system resources 30′, e.g. trading data such as purchase orders, production plans and so on, the system for reading authorized data 4 then accordingly read in the database 40 for data desired by the user. In this case, the ASP website 3′ is not necessarily employed for the user to obtained the desired data. This therefore decreases load of the ASP website 3′ in operation, and reduces cost for an enterprise in purchasing authorization from the ASP.

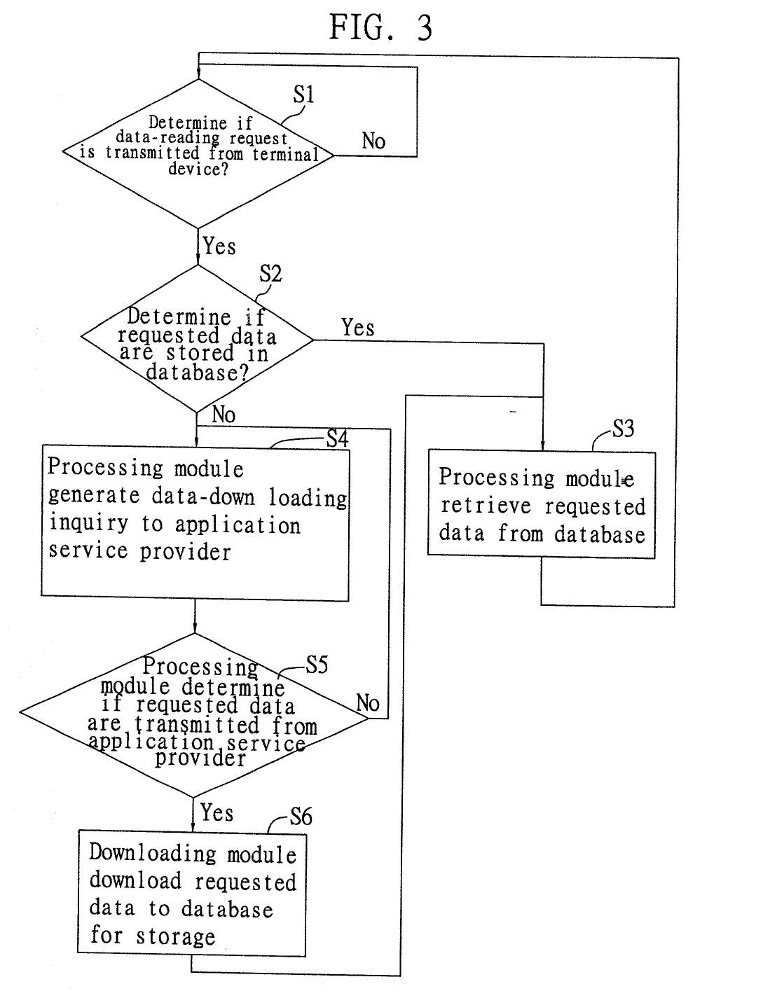

Referring to FIG. 3, it illustrates the steps depicting the method for reading authorized data in the use of the system for reading authorized data 4 of the invention. In the following, description is made with further reference to FIGS. 2 and 3.

First in step S1, the processing module 41 determines if a data-reading request is transmitted from the terminal device 1′. If the data-reading request is received by the processing module 41, then step S2 is followed; or else, the step S1 is repeated.

In step S2, the processing module 41 determines if data required by a user is stored in the database 40. If no required data is available, then step S4 is followed; or else, step S3 is followed.

In step S3, the processing module 41 retrieves the required data for the user from the database 40, and transmits the retrieved data to the browser 10′ of the terminal device 1′. Thereafter, the step S1 is repeated.

In step S4, the processing module 41 generates a data-downloading inquiry to the application service provider (ASP) website 3′ according to the data-reading request transmitted from the terminal device 1′, and then step S5 is followed, wherein the processing module 41 transmits an inquiry for reading a document number in a RFC manner to the ASP website 3′.

In step S5, the processing module 41 determines if the required data for the user are transmitted from the ASP website 3′. If no required data is received by the processing module 41, then the step S4 is repeated; or else, step S6 is followed. The ASP website 3′, in response to a RFC document number inquired by the processing module 41, retrieves data corresponding to the RFC document number from a database server (not shown) thereof, which is used to store trading data of enterprises, clients, or between the enterprises and clients.

In step S6, the processing module 41 allows the downloading module 42 to download the data received by the processing module 41 to the database 40 for storage, and then the step S3 is repeated, wherein the downloading module 42 processes the data received by the processing module 41 to be in the form of tables and downloads the tables to the database 40.

Therefore, in the use of the method and system for reading authorized data of the invention, cost can be reduced for an enterprise in purchasing authorization for using an application program system provided by the application service provider, and load of the application program system in operation can be decreased, since the user at the terminal device 1′ can obtain desired data with no need of the application service provider.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A method for reading authorized data, with a network connection established among a system for reading authorized data, a terminal device and an application service provider, for allowing a user at the terminal device to obtain data generated by operating an application program system of the application service provider in the use of the system for reading authorized data, wherein the system for reading authorized data is pre-formed with a database used for storing the data generated by operating the application program system; the method comprising the steps of:
(1) determining via the system for reading authorized data if a data-reading request is submitted by the user at the terminal device, wherein if the data-reading request is received by the system for reading authorized data, then step (2) is followed, or else, the step (1) is repeated;
(2) determining via the system for reading authorized data if data requested by the user is availably stored in the database, wherein if no data requested by the user is available, then step (4) is followed, or else, step (3) is followed;
(3) retrieving the data requested by the user via the system for reading authorized data from the database, and displaying the retrieved data on a browser of the terminal device; then, repeating the step (1);
(4) submitting a data-downloading inquiry via the system for reading authorized data to the application service provider according to the data-reading request submitted by the user;
(5) determining via the system for reading authorized data if the data requested by the user are transmitted from the application service provider, wherein if no data requested by the user is received by the system for reading authorized data, then the step (4) is repeated, or else, step (6) is followed; and
(6) downloading the requested data transmitted from the application service provider via the system for reading authorized data to the database for storage, and then repeating the step (3).

2. The method of claim 1, wherein in the step (4), the system for reading authorized data generates a data-reading inquiry to the application service provider in a request for comment (RFC) manner, so as to allow the application service provider to search in a database server thereof for data corresponding to a RFC document number in the data-reading inquiry.

3. The method of claim 1, wherein in the step (6), the system for reading authorized data processes the requested data transmitted from the application service provider to be in the form of tables, and downloads the tables to the database for storage.

4. The method of claim 1, wherein the application program system of the system for reading authorized data is an enterprise resource planning (ERP) system.

5. The method of claim 1, wherein the system for reading authorized data is constructed in a server host.

6. The method of claim 1, wherein the system for reading authorized data and the application service provider are constructed in world wide web.

7. A system for reading authorized data, with a network connection established among a system for reading authorized data, a terminal device and an application service provider, for allowing a user at the terminal device to obtain data generated by operating an application program system of the application service provider; the system comprising:
a database for storing the data generated by operating the application program system of the application service provider;
a processing module for receiving a data-reading request submitted by the user at the terminal device, and searching in the database for data requested by the user according to the received data-reading request, wherein if no data requested by the user is availably searched, the processing module submits a data-reading inquiry to the application service provider according to the received data-reading request; and
a downloading module for processing the data requested by the user when the processing module receiving the requested data transmitted from the application service provider, and storing the processed data in the database to be read by the user at the terminal device.

8. The system of claim 7, wherein the system for reading authorized data generates the data-reading inquiry to the application service provider in a request for comment (RFC) manner, so as to allow the application service provider to search in a database server thereof for data corresponding to a RFC document number in the data-reading inquiry.

9. The system of claim 7, wherein the downloading module processes the requested data transmitted from the application service provider to be in the form of tables, and downloads the tables to the database for storage.

10. The system of claim 7, wherein the application program system of the system for reading authorized data is an enterprise resource planning (ERP) system.

11. The system of claim 7, wherein the system for reading authorized data is constructed in a server host.

12. The system of claim 7, wherein the system for reading authorized data and the application service provider are constructed in world wide web.
